(19) United States
(12) Patent Application Publication
(10) Pub. No.: US 2026/0146627 A1
(43) Pub. Date: May 28, 2026

(54) SLURRY PUMP

(71) Applicant: Aki TUOMISALO, Espoo (FI)

(72) Inventor: Aki TUOMISALO, Espoo (FI)

(21) Appl. No.: 19/420,060

(22) Filed: Dec. 15, 2025

Related U.S. Application Data
(62) Division of application No. 18/547,908, now abandoned.

(30) Foreign Application Priority Data
Mar. 9, 2021 (EP) 21161588.5

(51) Int. Cl. F04D 29/42; F04D 7/04

(52) U.S. Cl. CPC F04D 29/426; F04D 7/045

(57) ABSTRACT

A slurry pump for mineral processing and a pump housing for a slurry pump. The pump housing includes a front part, a peripheral part, and a back part. The peripheral part includes one or more first protrusions and/or indentations configured to create a turbulent flow.

### CROSS REFERENCE TO RELATED APPLICATION

The present application is a divisional of U.S. patent application Ser. No. 18/547,908, filed Aug. 25, 2023, which application is the U.S. national stage application of International Application PCT/EP 2022/055813, filed Mar. 8, 2022, which international application was published on Sep. 15, 2022, as International Publication WO 2022/189391 A1 in the English language. The International Application claims priority European Patent Application No. 21161588.5 filed Mar. 9, 2021.

### FIELD OF THE DISCLOSURE

The present disclosure relates to a slurry pump for mineral processing, a pump housing for a slurry pump and an impeller for a slurry pump. The pump housing comprising a front part, a peripheral part, and a back part.

### BACKGROUND ART

Centrifugal pumps are known in the art of mineral processing for pumping slurries. Typically, such slurry pumps comprise an impeller supported on a shaft which is rotated by an external motor. The impeller is housed within a pump housing having an inlet for slurry and an outlet for discharging the pumped slurry, commonly referred to as the discharge. In use, slurry from the inlet flows towards the center of the impeller, whereby the rotation of the impeller forces the fluid to change direction towards the peripheral regions of the casing to be discharged through the discharge. The centrifugal forces resulting from the rotation of the impeller causes particles within the slurry to impact against the pump housing.

Particles of the slurry impacting against the pump housing and impeller may result in abrasive wear on those parts, severely affecting the lifetime of the pump housing and the impeller, and result in the need for frequent changing of parts. Frequent changing of the pump parts such as pump housing and impeller is both costly and leads to a large amount of downtime.

### SUMMARY

It is an object to mitigate, alleviate or eliminate one or more of the above-identified deficiencies in the art and disadvantages singly or in any combination and to solve at least the above-mentioned problems.

According to a first aspect of the disclosure, there is provided a slurry pump for mineral processing comprising:
a housing, an impeller arranged within the housing and a shaft for rotating the impeller around a first axis, wherein the housing comprises a front part, a back part, and a peripheral part,
wherein the housing comprises one or more first protrusions and/or indentations and wherein the one or more protrusions and/or indentations are configured to create a turbulent flow.

Consequently, by creating a turbulent flow, wear on the slurry pump caused by the abrasive slurry may be reduced. The turbulent flow created by the protrusions and/or indentations acts as a protective layer, which shields the pump housing from abrasive solids in a slurry pumped by the slurry pump. Preferably, the turbulent flow is created at least on a part of the back surface, at least a part of the front surface, and/or at least a part of the peripheral surface, where the first protrusions and/or indentations are arranged. The turbulent flow guides abrasive solids away from the peripheral part, hence significantly reducing wear on the inside of the pump housing provided with the protrusions and/or indentations.

The first protrusions and/or indentations are preferably configured to create a turbulent boundary layer, which may act as a protective layer deterring abrasive solids.

The one or more first protrusions and/or indentations may be formed by a plurality of different geometrical shapes. The one or more first indentations may for example be formed as dimples, grooves, cylindrical holes, square holes, depressions, etc. The one or more first protrusions may for example be formed as ribs, blocks, cubes, spikes, etc. In some embodiments the slurry pump comprises one or more first protrusions. In some embodiments the slurry pump comprises one or more first indentations. In some embodiments the slurry pump comprises one or more first protrusions and one or more first indentations.

Preferably, the one or more protrusions and/or indentations are formed with a sharp leading edge or a sharp trailing edge relative to the flow direction to facilitate the creation of a turbulent flow.

The one or more first protrusions and/or indentations may be formed on the front surface, peripheral surface, back surface, or a combination of these. The first protrusions and/or indentations may also be formed on the impeller of the pump.

In the context of this disclosure, a protrusion and an indentation may be interpreted as any shape which gives rise to an unevenness in the front surface, peripheral surface, or back surface, and which is able to create a turbulent flow.

In an embodiment the one or more first protrusions and/or indentations are formed as one or more ribs extending longitudinally in parallel with the first axis.

Consequently, a simple and easy to manufacture structure is provided which results in a turbulent flow being created. The one or more ribs may extend to form part of the front surface, and/or part of the back surface and/or part of the peripheral surface. Alternatively, the one or more first protrusions and/or indentations are formed as one or more grooves extending longitudinally in parallel with the first axis.

In an embodiment, the housing is a metallic housing and the peripheral part is formed by casting.

Consequently, the peripheral part is easy to manufacture even with complicated shapes. The metallic housing also allows for larger particle sizes and higher discharge pressures. Maximum particle size for this type of pumps can typically lie in an interval between 20 mm and 200 mm. However, larger maximum particle sizes are conceivable. A minimum particle size could be said to be 100 micron (μm). When it comes to discharge pressure, this type of pump, depending on size and casing material, can be considered to lie around 100-150 meters (TDH) for a metal pump and 30-60 meters (TDH) for rubber pumps.

In other embodiments, the peripheral part may be provided as a polymer liner for a pump, e.g. rubber. Furthermore, both the front part and the back part may also be provided as polymer liners.

In an embodiment the peripheral part is formed with a substantially U-shaped cross-section forming a first corner and a second corner, wherein the peripheral surface transitions to the front surface at the first corner, and wherein the peripheral surface transitions to the back surface at the second corner.

In an embodiment the one or more first protrusions and/or indentations are formed at the first corner and/or the second corner.

In an embodiment the one or more first protrusions and/or indentations are formed between the first corner and the second corner.

In some cases, the wear caused by abrasive solid in a pumped slurry is the highest at different boundary zones, e.g. corners of the peripheral part. Consequently, by forming the one or more first protrusions and/or indentations at these boundary zones wear might be reduced at the boundary zones.

In an embodiment a first section of the peripheral part forms a cut water region, and the first one or more protrusions and/or indentations are formed at least at the first section.

The cut water region is a boundary zone where high amount of wear has been observed by the applicant. Consequently, by forming the one or more first protrusions and/or indentations at the cut water region wear might be reduced at the cut water region.

The cut water region may be defined as the section of the peripheral part extending closest to the impeller of the pump. The cut water region may be defined as the section of the peripheral part defining an opening for a discharge. Thus, in an embodiment, the first section of the peripheral part defines an opening for a discharge of the housing.

In an embodiment the peripheral part is substantially circular and comprises a plurality of first protrusions and/or indentations arranged along the inner perimeter of the peripheral part.

The plurality of first protrusions and/or indentations may be arranged at a section of the inner perimeter of the peripheral part, alternatively the plurality of first protrusions and/or indentations may be placed uniformly over the whole inner parameter of the peripheral part.

In embodiments where the slurry pump comprises a plurality of protrusions and/or indentations, the protrusions and/or indentations within the plurality may correspond to each other or differ from each other.

In an embodiment the plurality of first protrusions and/or indentations are arranged equidistantly from each other.

Consequently, the turbulent flow created by the plurality of first protrusions and/or indentations may extend to create a uniform protective layer. The plurality of first protrusions and/or indentations may be arranged with a periodicity of 0.5-10 cm, e.g. 1, 2, 3, 4, 5, 6, 7, 8, 9, or 10 cm. A preferred interval could be 0.6-1.0 cm. Alternatively, the plurality of first protrusions and/or indentations may be placed with varying periodicities, i.e. non equidistantly from each other. This might be advantageous to accommodate for a varying distance to the impeller, or to accommodate for other features of the pump.

In an embodiment the plurality of first protrusions and/or indentations may be arranged in a plurality of groups, wherein the plurality of first protrusions and/or indentations are equidistantly within the plurality of groups. For example, a first plurality of first protrusions and/or indentations may be arranged at a cut water region of the peripheral part, and a second plurality of first protrusions and/or indentations may be placed in a corner formed by the peripheral part.

In an embodiment the plurality of first protrusions and/or indentations are configured for creating a turbulent flow along the whole inner perimeter of the peripheral part.

Consequently, a protective layer for reducing wear may be created which fully cover the inner perimeter of the peripheral part, and thus results in a reduction of wear.

In an embodiment the slurry pump further comprises a discharge part forming a discharge from the housing, wherein the discharge comprises one or more second protrusions and/or indentations configured to create a turbulent flow at an inner surface of the discharge part.

Consequently, a protective layer is formed on the inner surface of the discharge part, hence reducing wear on the discharge part.

In some embodiments the discharge part and the peripheral part are formed integrally with each other. Alternatively, the discharge part and the peripheral part may be integrally connected to each other, e.g. by bolting or other fastening means. The same applies to the connection between the discharge part and the peripheral part.

The one or more second protrusions and/or indentations may correspond to the one or more first protrusions and/or indentations or differ from these.

In an embodiment the one or more protrusions and/or indentations has a height of 1-10 mm, preferably 3-5 mm.

The applicant has found a height of 1-10 mm is sufficient for creating a strong enough turbulent flow for deterring most abrasive solid from impacting negatively with the peripheral part.

According to a second aspect of the disclosure, there is provided a retrofit kit for retrofitting a slurry pump for mineral processing, the retrofit kit comprising a housing having a front surface, a back surface, and a peripheral surface,
wherein the housing comprises one or more first protrusions and/or indentations configured to create a turbulent flow.

In an embodiment the retrofit kit further comprises a discharge part configured to form a discharge from the housing, wherein the discharge comprises one or more second protrusions and/or indentations configured to create a turbulent flow at an inner surface of the discharge part.

In an embodiment the retrofit kit further comprises a front part, and a back part,
wherein the peripheral part and the front part are configured to form a front surface of the housing extending perpendicular to the first axis and facing the impeller,

wherein the peripheral part and the back part are configured to form a back surface of the housing being opposite the front surface and extending perpendicular to the first axis and facing the impeller.

According to a third aspect of the disclosure, there is provided a method for reducing wear in a slurry pump for mineral processing, comprising the steps of:
providing a slurry pump for mineral processing according to the first aspect of the invention,
pumping a slurry with the slurry pump, wherein the slurry pump is configured to generate a turbulent flow for reducing wear.

According to a fourth aspect of the disclosure, there is provided a pump housing for a slurry pump, the pump housing comprising:
a front part, a back part, and a peripheral part,
wherein the pump housing comprises one or more first protrusions and/or indentations configured to create a turbulent flow.

It is noted that the invention relates to all possible combinations of features recited in the claims. Other objectives, features, and advantages of the present inventive concept will appear from the following detailed disclosure, from the attached claims as well as from the drawings. A feature described in relation to one of the aspects may also be incorporated in the other aspect, and the advantage of the feature is applicable to all aspects in which it is incorporated.

Hence, it is to be understood that this disclosure is not limited to the component parts of the device described or steps of the methods described as such device and method may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The disclosure will by way of example be described in more detail with reference to the appended schematic drawings, which show presently preferred embodiments of the disclosure.

FIG. 1 shows an exploded perspective view of a pump housing according to an embodiment of the invention.

FIG. 2 shows a schematic cross-sectional view of the pump housing according to an embodiment of the invention.

FIG. 3 shows a schematic cross-sectional view of a detail according to an embodiment of the invention.

FIG. 4 shows a schematic cross-sectional view of a detail according to an embodiment of the invention.

FIG. 5 shows a schematic cross-sectional view of a detail according to an embodiment of the invention.

### DETAILED DESCRIPTION

The present disclosure will now be described more fully hereinafter with reference to the accompanying drawings, in which currently preferred embodiments of the disclosure are shown. This disclosure may, however, be embodied in many different forms and should not be construed as limited to the embodiments set forth herein; rather, these embodiments are provided for thoroughness and completeness, and to fully convey the scope of the disclosure to the skilled person.

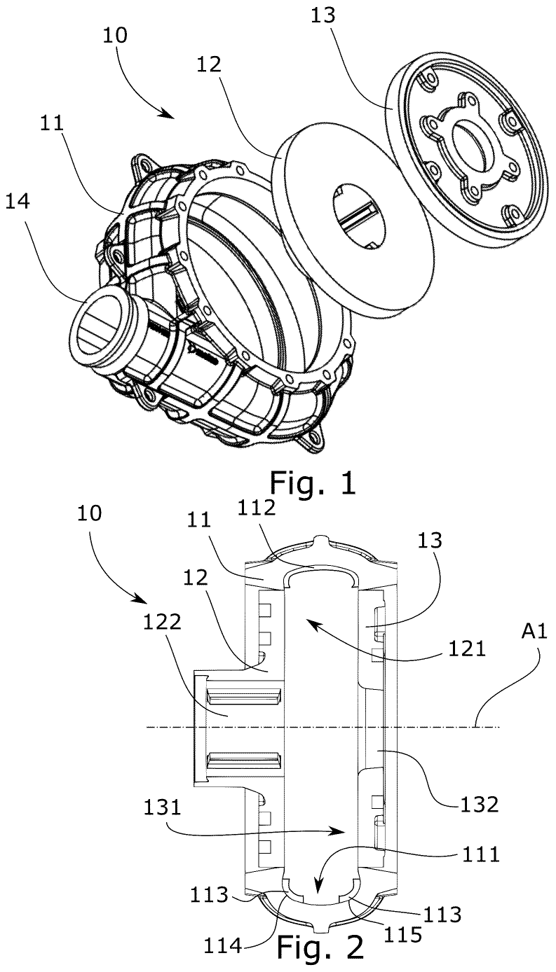

FIG. 1 shows an exploded perspective view of a pump housing 10 according to an embodiment of the invention. The pump housing 10 being configured to be used for a slurry pump for mineral processing. The pump housing 10 comprises a front part 12, a back part 13, and a peripheral part 11. The pump housing 10 is configured to house an impeller rotating around a first axis A1, which can be seen in FIG. 2.

The peripheral part 11 being formed with a substantially circular cross-section in a plane perpendicular to the first axis A1. The peripheral part 11 is formed with a through-going opening for receiving the front part 12 and the back part along the first axis A1. Formed integrally with the peripheral part 11 is a discharge 14. The discharge 14 extends substantially tangentially from the peripheral part 11. The pump housing 10 is a metallic housing. In other embodiments the pump housing 10 may be partly metallic and partly made from a polymer, such as rubber, e.g. the pump housing may comprise an outer housing of metal where rubber liners have been connected to form an inner housing. The peripheral part 11 may be formed by casting or other metallurgy techniques, the same follows for the back part 13 and the front part 12.

Referring to FIG. 2 which depicts a schematic cross-sectional view of the pump housing 10 according to an embodiment of the invention. The pump housing 10 is shown in an assembled state where the front part 12 and the back part 13 are connected to the peripheral part 11. Furthermore, the front part 12 comprises an inlet 122 for allowing a slurry to enter the pump housing 10 along the first axis A1. The back part 13 comprises an opening 132 to allow a drive shaft to enter the pump housing 10 to drive an impeller arranged within the pump housing 10.

The peripheral part 11 and the front part 12 forms a front surface 121 of the pump housing 10. The front surface 121 extends perpendicular to the first axis A1 and faces an interior of the pump housing 10. The peripheral part 11 and the back part 13 forms a back surface 131 of the pump housing 10. The back surface 131 extends perpendicular to the first axis A1 opposite the front surface 121 and faces an interior of the pump housing 10. The peripheral part 11 forms a peripheral surface 111 extending in-between the front surface 121 and the back surface 131 in parallel with the first axis A1 and facing the interior of the housing. The front surface 121, the back surface 131, and the peripheral surface 111 delimit a space wherein the impeller is received.

The peripheral part 11 comprises a plurality of first protrusions 112, 113. The plurality of first protrusions 112, 113 extends from at least part of the back surface 131, at least part of the front surface 121, and at least part of the peripheral surface 111. The plurality of first protrusions is configured to create a turbulent flow at the at least part of the back surface 131, the at least part of the front surface 121, and the at least part of the peripheral surface 111. In the shown embodiment one of the protrusions 112 of the plurality of first protrusions 112, 113 is formed as a rib 112. The rib 112 extends longitudinally in parallel with the first axis A1. The rib 112 is formed partly on the front surface 121, partly on the peripheral surface 111, and partly on the back surface 113.

The peripheral part 11 is formed with a substantially U-shaped cross-section in a plane parallel to the first axis A1. The U-shaped cross-section forms a first corner 114 and a second corner 115. The peripheral surface 111 transitions to the front surface 121 at the first corner 114. The peripheral surface 111 transitions to the back surface 131 at the second corner 115. A rib 113 is arranged at each of the first corner 114 and the second corner 115. The ribs 113 being configured for creating a turbulent flow at the first corner 114 and the second corner 115.

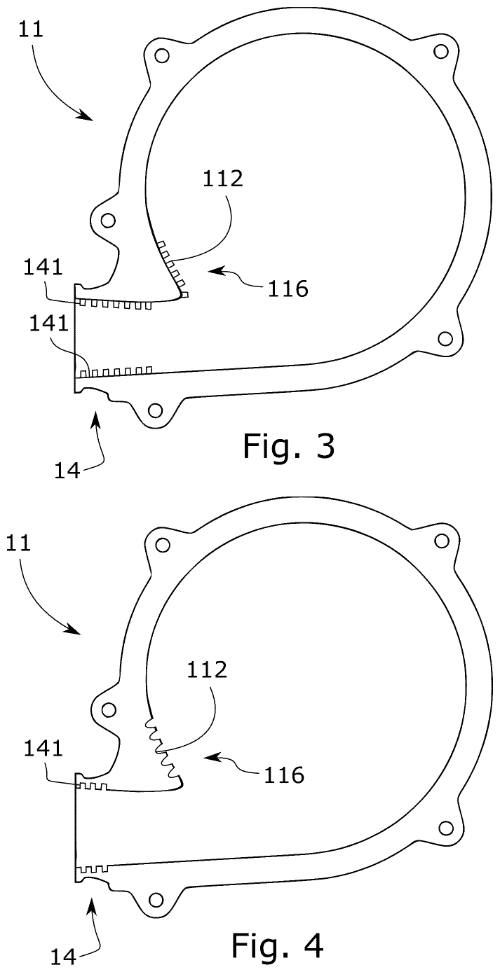

Referring to FIG. 3 showing a schematic cross-sectional view of the peripheral part 11 according to an embodiment of the invention. The peripheral part 11 is formed with a substantially circular cross-section in a plane perpendicular to the first axis A1. The peripheral part 11 comprises a first section 116 which forms a cut water region 116. The peripheral part 11 comprises a plurality of first protrusions 112 arranged at the cut water region 116. The plurality of first protrusions 112 are arranged along an inner perimeter of the peripheral part 11. The plurality of first protrusions 116 being configured for creating a turbulent flow at the cut water region 116 to reduce wear at the cut water region 116. The plurality of first protrusions 112 may be arranged equidistantly away from each other. The plurality of first protrusions 112 have a height of 1-10 mm, preferably 3-5 mm. Integrally formed with the peripheral part 11 is the discharge part 14. The discharge part 14 forms a discharge from the pump housing 10. In the shown embodiment, the discharge part 14 comprises a plurality of second protrusions 141. The plurality of second protrusions 141 are configured to create a turbulent flow at an inner surface 142 of the discharge part 141.

Referring to FIG. 4 showing a schematic cross-sectional view of the peripheral part 11 according to an embodiment of the invention. The peripheral part 11 shown in FIG. 4 is almost identical to that of FIG. 3. However, instead of protrusions the peripheral part 11 and the discharge 14 is provided with a plurality of first indentations 112 and a plurality of second indentations 141. The plurality of first indentations 112 being configured for creating a turbulent flow. The plurality of first indentations 112 may be arranged as a plurality of dimples 112, thus achieving a similar effect as what is observed for golf balls. Alternatively, or in combination, the plurality of indentations 112, 141 may be formed as grooves. The plurality of first indentations 112 have a height of 1-10 mm, preferably 3-5 mm. Alternatively, it may be formulated as the plurality of first indentations 112 having a depth of 1-10 mm, preferably 3-5mm.

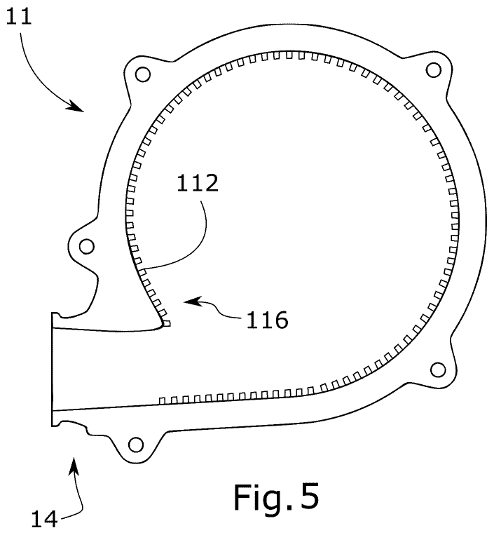

Lastly, referring to FIG. 5 showing a schematic cross-sectional view of the peripheral part 11 according to an embodiment of the invention. The peripheral part 11 shown in FIG. 5 is almost identical to that of FIG. 3. However, the discharge 14 comprises no protrusions, while the peripheral part 11 comprises a plurality of first protrusions 112 arranged along the inner perimeter of the peripheral part 11. The plurality of first protrusions 112 are arranged along the whole inner perimeter of the peripheral part 11. The plurality of first protrusions 112 are configured for creating a turbulent flow along the whole inner perimeter of the peripheral part 11. Consequently, protecting the whole inner perimeter of the peripheral part 11 from abrasive solids.

The person skilled in the art realizes that the present disclosure by no means is limited to the preferred embodiments described above. On the contrary, many modifications and variations are possible within the scope of the appended claims.

For example, although the described embodiments above do not show the combination of indentations with protrusions, it is possible to use a combination of indentations and protrusions, e.g. indentations may be used at the discharge while protrusions are used for the peripheral part, or vice versa.

Additionally, variations to the disclosed embodiments can be understood and effected by the skilled person in practicing the claimed disclosure, from a study of the drawings, the description, and the appended claims.

1. A slurry pump for mineral processing comprising:
a housing and an impeller arranged within the housing and a shaft for rotating the impeller around a first axis, wherein the housing comprises a front part, a back part, and a peripheral part comprising a cut water region, wherein the cut water region is a section of the peripheral part defining an opening for a discharge from the pump housing,
wherein the housing comprises a plurality of first protrusions and/or indentations formed at least at the cut water region, wherein the plurality of first protrusion and/or indentations is arranged in a plurality of groups, wherein the plurality of first protrusions and/or indentations are equidistantly within the plurality of groups, and wherein the plurality of first protrusions and/or indentations are configured to create a turbulent flow.

2. The slurry pump according to claim 1, wherein the plurality of first protrusions and/or indentations are formed as one or more ribs extending longitudinally in parallel with the first axis.

3. The slurry pump according to claim 1, wherein the housing is a metallic housing and the peripheral part is formed by casting.

4. The slurry pump according to claim 1, wherein the peripheral part is formed with a substantially U-shaped cross-section forming a first corner and a second corner, wherein a peripheral surface of the peripheral part transitions to the front surface at the first corner, and wherein the peripheral surface transitions to the back surface at the second corner.

5. The slurry pump according to claim 4, wherein the plurality of first protrusions and/indentations are formed at the first corner and/or the second corner.

6. The slurry pump according to claim 1, wherein a first section of the peripheral part forms a cut water region, and wherein the plurality of first protrusions and/or indentations are formed at least at the first section.

7. The slurry pump according to claim 6, wherein the first section of the peripheral part defines an opening for a discharge of the housing.

8. The slurry pump according to claim 1, wherein the peripheral part is substantially circular and comprises a plurality of first protrusions and/or indentations arranged along the inner perimeter of the peripheral part.

9. The slurry pump according to claim 8, wherein the plurality of first protrusions and/or indentations are arranged equidistantly from each other.

10. The slurry pump according to claim 8, wherein the plurality of first protrusions and/or indentations are configured for creating a turbulent flow along the whole inner perimeter of the peripheral part.

11. The slurry pump according to claim 1, further comprising a discharge part forming a discharge from the housing, wherein the discharge comprises one or more second protrusions and/or indentations configured to create a turbulent flow at an inner surface of the discharge part.

12. The slurry pump according to claim 1, wherein the plurality of protrusions and/or indentations has a height of 3-5 mm.

13. A retrofit kit for retrofitting a slurry pump for mineral processing, the retrofit kit comprising a housing comprising a front surface, a back surface, and a peripheral surface,
wherein the front surface is configured for facing an impeller arranged in the housing rotating around a first axis,
wherein the back surface is opposite the front surface and facing the impeller,
wherein the peripheral surface extends in-between the front surface and the back surface,
wherein the housing comprises a plurality of first protrusions and/or indentations, wherein the plurality of first protrusions are configured to create a turbulent flow, and
wherein the housing comprises a plurality of first protrusions and/or indentations formed at least at the cut water region, wherein the plurality of first protrusion and/or indentations is arranged in a plurality of groups, wherein the plurality of first protrusions and/or indentations are equidistantly within the plurality of groups, and wherein the plurality of first protrusions are configured to create a turbulent flow.

14. The retrofit kit according to claim 13, further comprising a discharge part configured to form a discharge from the housing, wherein the discharge comprises one or more second protrusions and/or indentations configured to create a turbulent flow at an inner surface of the discharge part.

15. The retrofit kit according to claim 13, further comprising a front part, and a back part,
wherein the peripheral part and the front part are configured to form a front surface of the housing extending perpendicular to the first axis and facing the impeller,
wherein the peripheral part and the back part are configured to form a back surface of the housing being opposite the front surface and extending perpendicular to the first axis and facing the impeller.

16. A slurry pump for mineral processing comprising:
a housing and an impeller arranged within the housing and a shaft for rotating the impeller around a first axis, wherein the housing comprises a front part, a back part, and a peripheral part comprising a cut water region, wherein the cut water region is a section of the peripheral part defining an opening for a discharge from the pump housing,
wherein the housing comprises a plurality of first protrusions and/or indentations formed at least at the cut water region, and being integrally formed with the housing, wherein the plurality of first protrusions and/or indentations are configured to create a turbulent flow, wherein the peripheral part is formed with a substantially U-shaped cross-section forming a first corner and a second corner, wherein a peripheral surface of the peripheral part transitions to the front surface at the first corner, and wherein the peripheral surface transitions to the back surface at the second corner, and
wherein the plurality of first protrusions and/indentations are formed at the first corner and/or the second corner.

17. A pump housing for a slurry pump for mineral processing, the pump housing comprising:
a front part, a back part, and a peripheral part comprising a cut water region, wherein the cut water region is a section of the peripheral part defining an opening for a discharge from the pump housing,
wherein pump housing comprises a plurality of first protrusions and/or indentations formed at least at the cut water region, wherein the plurality of first protrusion and/or indentations is arranged in a plurality of groups, wherein the plurality of first protrusions and/or indentations are equidistantly within the plurality of groups, and wherein the plurality of first protrusions and/or indentations are configured to create a turbulent flow.
